(19) United States
(12) Patent Application Publication
(10) Pub. No.: US 2007/0049510 A1
(43) Pub. Date: Mar. 1, 2007

(54) Two-step coating removal process

(76) Inventors: Gary Fujii, Rancho Palos Verdes, CA (US); William A. Ernst, Fountain Valley, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/510,180

(22) Filed: Aug. 24, 2006

Related U.S. Application Data
(60) Provisional application No. 60/713,257, filed on Aug. 31, 2005.

(51) Int. Cl. C09D 9/00

(52) U.S. Cl. 510/201

(57) ABSTRACT

Paint stripping formulations and a two-step paint removal process is provided. The formulation and process provides an efficient method of removing paints from different surfaces. More specifically, a two-step coating or paint removal process that consists of the application of a stripping formulation that separates the coating from the surface that it is bonded to and then applying a liquid-to-solid matrix material that, upon drying, resulting in a solid matrix that binds to the stripped coating thus facilitating removal by simple physical methods such as peeling of the solid matrix is provided. Additionally, the present invention provides preferred compositions of the coating removal step of the two-step process.

### PRIORITY STATEMENT

This application claims priority to the earlier filed U.S. Provisional Application Ser. No. 60/713,257, and further having a filing date of Aug. 31, 2005.

### BACKGROUND OF THE INVENTION

Chemical formulations for stripping paints are widely used in a number of industrial and consumer applications ranging from the finishing and refinishing of manufactured articles to the clean-up of painting facilities. Paint strippers are also used in the refinishing of commercial and military aircraft and ships as well as the manufacture and refinishing of motor vehicles. In addition, the removal of graffiti from public and private structures including buildings, walls and signs make use of paint stripping formulations.

A major requirement for a good paint stripping formulation is that it efficiently and effectively removes a variety of paints without harming the underlying base material. For many years, paint strippers based on methylene chloride were used because of its effectiveness in quickly stripping most types of paints. However, the use of methylene chloride has become an issue due to concerns regarding toxicity to humans and the environment as well as the release of volatile or halogenated organic compounds, such as methylene chloride, into the air. Because of these concerns, new regulations have strictly curtailed the amount of volatile organic compounds and/or hazardous air pollutants released into the environment. These restrictions have had a significant impact on the paint stripping industry because they are normally applied in relatively large volumes and distributed over large exposed areas.

Thus, there is a need for novel paint stripping formulations that have low or no volatile and/or hazardous organic compounds but maintain the effectiveness of methylene chloride. In addition, it is important for new paint stripper formulations to be able to strip paint from a variety of base materials such as glass, tile, plasterboard, steel, aluminum, magnesium alloys, concrete, brick, wood and the like without causing any damage to the substrate. This issue is of particular significance to the aircraft and shipping industries, since they are often manufactured using lightweight aluminum or magnesium based alloys or other materials which can be easily corroded by acidic or alkaline materials.

Another issue that is of concern in the paint stripping industry is providing an effective means of removing the stripped paint from the base material. Current processes tend to be messy and time consuming. They also cause an undue amount of exposure to the persons doing the stripping and to the environment. Finally, the problem of disposal of the paint that has been stripped is also an area for concern. It would thus fill a great need to be able to devise a process for effectively and efficiently stripping paint from a base material without harming people or the environment.

### SUMMARY OF THE INVENTION

This invention relates generally to paint stripping formulations and to a two-step paint removal process that provides a relatively efficient method of removing paints from different surfaces. More specifically, the invention discloses a two-step coating or paint removal process that consists of the application of a stripping formulation that separates the coating from the surface that it is bonded to and then applying a liquid-to-solid matrix material that, upon drying, results in a solid matrix that binds to the stripped coating thus facilitating removal by simple physical methods such as peeling of the solid matrix. Also disclosed are preferred compositions of the coating removal step of the two-step process.

A number of paint-stripping compositions that can be used in this two-step process are known in the prior art. For example, U.S. Pat. Nos. 5,454,985 and 6,165,957 and U.S. patent application Ser. No. 08/610,155 disclose paint-stripping compositions based upon mixtures of benzyl alcohol and water, which compositions may also include acidic or alkaline accelerators as well as peroxide activators. U.S. Pat. No. 3,355,385 discloses paint-stripping compositions based upon aqueous hydrogen peroxide in combination with various organic solvents, including methylene chloride, and other halocarbons. U.S. Pat. Nos. 5,518,661 and 4,445,939 describe paint-stripping compositions based upon specific mixtures of benzyl alcohol and methylene chloride. U.S. Pat. Nos. 4,645,617, 6,482,270 and 6,548,464 disclose paint stripping formulations that contain alkylene carbonates in combination with benzyl alcohol, methylene chloride or dimethyl sulfoxide, glycol ethers or ketones. U.S. Pat. No. 5,106,525 teaches the use of gamma-butyrolactone in paint stripping formulations. U.S. Pat. Nos. 5,334,331 and 6,030,466 details the use of tetrahydrofurfuryl alkyl ethers alone or in combination with N-methyl pyrrolidone to strip paint from surfaces. U.S. Pat. No. 6,417,149 discloses the use of methyl benzoate and formic acid in a paint stripping composition. In addition, U.S. Pat. No. 5,990,062 describes the use of auxiliary agents such as evaporation retardants, surfactants, pH control agents, accelerators, corrosion inhibitors, dyes or fragrances in paint stripping formulations. The prior art has thus made many attempts at formulating paint-stripping compositions, yet, there is still room for improvement in terms of developing non-corrosive, low-toxicity, environmentally friendly paint-stripping compositions without volatile and/or halogenated organics, and hazardous compounds.

As used herein, liquid-to-solid matrix materials refers to compositions that can either be true solutions or dispersions of matrix materials, as defined below, that are applied in the liquid state, but upon drying, transition to a solid state that possesses the properties outlined below. Examples of liquid-to-solid matrix materials that are suitable for this invention can be found in the prior art. For example, U.S. Pat. No. 5,421,897 describes the use of polymeric materials, rubber compounds, either synthetic or natural, neoprene, latex, acrylonitrile-containing copolymers, chlorinated rubbers, and the like, as useful liquid-to-solid matrix materials.

### DETAILED DESCRIPTION OF THE INVENTION

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

Step 1. Application of a Paint Stripper

The first step of the present invention involves the application of a suitable paint stripping formulation to the painted surface. Ideally, the paint stripper separates the paint from the underlying base material within a short period of time, preferably, within minutes. In one embodiment, the preferred paint stripping formulation should be comprised of low to non-volatile components and pose minimal environmental or toxicological hazards. As used herein, the “base material” refers to, but is not limited to, materials to which paint may be applied, for example, glass, wood, metals, tile, plasterboard, concrete, cinder block, brick, rock, plastic and the like.

Any conventional method of application such as pouring, rolling, manual or assisted spreading, brushing, aerosol spraying, air or airless spraying is suitable. Generally, the paint stripping formulation should be applied at a thickness at least as great as the thickness of the coating to be removed. As contact is initiated, the paint stripper formulation begins to interact with the paint by penetration of the paint down to the interface with the base material where the active components of the paint stripper act to separate the paint from the surface of base material. On nonporous surfaces like painted plasterboard, painted wood, glass and floor tile, the application of the paint stripping formulation should be relatively straightforward. On highly porous surfaces, such as cinder block and concrete, the paint stripping formulation may need to be manually or power brushed, scrubbed or scoured to adequately penetrate the materials.

Also disclosed herein are preferred paint-stripping formulations which comprise, on a weight (volume) basis, at least 15-50% of benzyl alcohol or an alkyl substituted benzyl alcohol, together with 1-15% hydrogen peroxide, 10-40% of a carbonate such as propylene, ethylene, butylene or glycerine carbonate, together with 0-60% of water. In some specific embodiments, the benzyl alcohol is present in an amount of 20-30% by weight (volume), the hydrogen peroxide is present in an amount of 5-10% by weight, the glycerine carbonate is present in an amount of 15-25% by weight, and the water is present in an amount of 35-55% by weight. In a preferred embodiment, a formulation containing 25-30% benzyl alcohol, 2-5% hydrogen peroxide, 10-20% glycerine carbonate and 35-50% water on a final concentration basis is disclosed. Generally, hydrogen peroxide is added to the paint stripping formulation as a 30-35% solution in water. Thus, the preferred formulations of the invention are prepared by diluting aqueous hydrogen peroxide solutions with the other components and adding water to achieve the desired percentages. The composition may also include one or more additive agents such as thickeners, evaporation retardants, surfactants, pH control agents, corrosion inhibitors, preservatives, coloring agents, and fragrances; and these auxiliary ingredients may comprise up to 10% by weight of the composition. In some cases, acidic accelerators may also be included in the composition.

In the present invention, it has been found that alkylene carbonates, water, peroxides, and a benzyl alcohol can be formulated to produce a highly effective paint-stripping composition with low volatility and a pleasant odor. Although the components of the preferred paint stripper formulation of the present invention may be present in various concentrations, it has been found that the specified compositional ranges and ratios of the materials provide excellent stripping action against paints while maintaining the parameters of low or no volatile organics or halocarbons, non-toxic, and being environmentally friendly. Various components of the stripper of the present invention will be discussed individually below, and various examples of the formulations will be presented; and unless otherwise noted, all compositions presented herein are on the basis of weight.

Benzyl Alcohol. An active component of the preferred formulation of the present invention is a benzyl alcohol. Generally, the benzyl alcohol will be unsubstituted; however, various alkyl substituted benzyl alcohols, such as mono- and di-methyl and ethyl benzyl alcohols (including the alpha, ortho, meta and para isomers) are known, and such materials may also be employed in the present invention. Hence, it is to be understood that the term “a benzyl alcohol” refers to substituted benzyl alcohols as well as the unsubstituted form. In a preferred embodiment, benzyl alcohol is present in amounts of at least 15%. In one preferred group of formulations, the benzyl alcohol comprises approximately 25-30% of the composition.

Peroxides. A peroxide is another active component of the preferred paint stripping formulation of the present invention. The most preferred peroxide of the present invention is hydrogen peroxide, and is present in an amount of 1-15% of the paint stripping formulation. In one particularly preferred formulation, the hydrogen peroxide is present on an absolute basis in an amount of approximately 5%. It should also be noted that other peroxides, such as organic peroxides may also be used in the present invention, and the appropriate amounts thereof calculated on the basis of their molar equivalence to hydrogen peroxide.

Alkylene carbonate. Alkylene carbonates are also an active ingredient of the preferred stripping formulations of the present invention. As detailed herein, it is significant that the presence of the alkylene carbonates, especially glycerine carbonate, provides a single solution phase paint stripper with good activity. In general, the alkylene carbonate should be present in an amount of at least 10% of the composition. In a preferred formulation, it has been found that approximately 15-25% glycerine carbonate in combination with 25-30% benzyl alcohol, 5% hydrogen peroxide and the remainder water provides a single phase solution possessing excellent stripping action.

Water. In the preferred paint stripping formulation of the present invention, water is one of the primary solvents. In addition to promoting the stripping activity, water also reduces the cost of the formulation and makes handling much simpler. In the preferred formulations of the present invention, water is comprises 10-60% of the formulation. One particularly preferred range of concentration for water is 35-55%, and in a specific stripper formulation, water comprises approximately 40-50% of the material.

Additive Agents. While the foregoing components provide the basis for the preferred paint-stripping formulations of the present invention, in many instances, additives will also be present in the stripping formulations. Examples of such additive agents might include thickeners, evaporation retardants, surfactants, pH control agents, corrosion inhibitors, preservatives, dyes and fragrances. For example, cellulose esters such as methyl cellulose, ethyl cellulose and the like may be included to increase the viscosity of the material to produce a paint stripper formulation capable of adhering to non-horizontal surfaces.

Although the components of the preferred paint stripping formulations of the present invention are not considered volatile, some compositions often include evaporation retardants in the mixture to further decrease the rate of evaporation of volatile materials therefrom. Such evaporation retardants are well known in the art and include materials such as glycerine, wax, high molecular weight esters and the like. Surfactants such as Tergitols, Petro LBA and the like may also be advantageously included in the formulations since they will facilitate the wetting of the paint being stripped by the formulations, and may assist in maintaining a single solution phase by enhancing solubilization, or emulsification of the various materials comprising the stripper.

The preferred paint stripping formulations of the present invention have compositions that are active and effective under relatively mild pH conditions, and thereby will not harm reactive alloys such as those found in aircraft. Ideally, paint stripping formulations of the present invention should operate under neutral to near neutral pH conditions, typically in the range of pH 4-9. Acids or alkalis may be added to the formulations to adjust the pH, and buffers may be included to assure that the pH remains stable. Corrosion inhibitors such as benzotriazole, 2-mercaptothiazole and the like may be included in relatively low concentrations to prevent corrosion of metal surfaces, and/or to protect reactive metal surfaces from atmospheric corrosion, once stripping is complete. Preservatives such as citrates, benzoates, and the like may be included, as in known in the art, to prevent growth of unwanted microbes in the material. Also, dyes, fragrances and the like may be added to enhance the aesthetic appeal of the stripping formulation. In general, the additive agents should collectively comprise no more than 10% of the weight of the paint stripping formulation. It should also be noted that while the preferred formulations of the present invention are used at neutral to near neutral pH conditions, some specific applications may require paint formulations that contain accelerators such as acids or alkalis, as is known in the art, to further promote the stripping ability thereof.

One preferred group of acidic accelerators comprises the organic acids. Some examples of the most preferred organic acidic accelerators include, but are not limited to, formic acid, acetic acid, propionic acid, glycolic acid, succinic acid and their corresponding halogenated forms. As previously described, and as demonstrated herein, the peroxide component of the formulations interacts, beneficially, with the acid to accelerate the rate of the lifting of the paint from the coated surface. Only relatively small amounts of acid (typically 3-7%) are required to accelerate the stripping action. Such low acid concentrations do not greatly enhance the corrosivity of the acid accelerated strippers, making them particularly suitable for aircraft alloys. Likewise, the presence of the acid allows for a lowering of the peroxide content to less than 5%, without significantly slowing down the rate of stripping, and additionally, improving the stability of the formulation. In a preferred embodiment, glycolic acid is present in a paint stripping formulation at around 7%.

Step 2. Application of the Liquid-To-Solid Matrix Material

In the second step of this invention, painted surfaces that have been treated with any of the paint stripping formulations described above can be removed by applying a liquid-to-solid matrix material to a horizontal or vertical surface, allowing the liquid-state composition to solidify to the solid-state matrix containing the stripped paint, and then removing the solid-state matrix containing the paint from the surface of the base material by simple physical methods. Typical base materials include wood, concrete, brick, cinder block, plasterboard, plastic, wallboard, aluminum, steel, iron, formica, glass or even rock. The liquid-to-solid matrix material is preferably a polymer composition which may contain one or more optional additives that enhance the two-step paint stripping process described herein. Representative suitable polymer components and optional additives are discussed in detail below.

Any conventional method of application such as pouring, rolling, manual or assisted spreading, brushing, aerosol spraying, air or airless spraying is suitable. Generally, the liquid-to-solid matrix material is applied at between 10 to 60 mils wet film thickness. As contact with the stripped paint begins to take place, the liquid-to-solid matrix material interacts with the loosened paint through wetting, molecular aggregations, micellular inclusion, dispersion, suspension and solubilization into the liquid-to-solid matrix material. On nonporous surfaces like plasterboard, wood, glass and floor tile, the application of the liquid-to-solid matrix material by spraying of brushing to the painted surface may be sufficient to cause the binding to the loosened paint. On highly porous surfaces, such as cinder block and concrete, the liquid-to-solid matrix material may be manually or power brushed, scrubbed or scoured to assist in the penetration and contact of the liquid-to-solid matrix material into the stripped paint.

After the liquid-to-solid matrix material has been applied to the paint stripped surface, it is allowed to form the solid-state matrix. This process typically occurs by the evaporation of the carrier solvents, or can be hastened by the use of chemical or physical drying agents. As the liquid-to-solid matrix material loses its liquid carrier/solvent component, a transition to the solid state occurs and the soluble or dispersed polymeric material forms the solid-state matrix that binds to the loosened paint. As used herein, term “binds” includes all physical and chemical means by which the paint becomes associated with the solid state matrix, including absorption, adsorption, physical entrapment, chemical reactions, and the like. In a preferred embodiment, complete evaporation of the carrier/solvent component should result in a solid-state matrix possessing a high degree of tear, tensile and cohesive strengths. The preferred solid-state matrix should display a cohesive-to-adhesive strength ratio that has a value of at least about one and is capable of being removed from the applied surface by simple physical peeling. Release aids may be included in the liquid-to-solid matrix material to achieve the proper ratio of cohesive-to-adhesive strengths and facilitate removal.

While the solid-state matrix may display a high degree of elongation (200 to 1000%), the physical and chemical interactions with the paint should be sufficient to prevent separation from the paint upon peeling. The solid-state matrix located in pores, cracks, crevices and the like should be pulled from these regions upon removal of the overall solid-state matrix and remains bound to the bulk of the solid-state matrix upon peeling. Once removed, the solid-state matrix may be rolled, folded or compacted in convenient sizes and shapes, and bagged for subsequent treatments or processed as is for disposal.

While a single application is usually adequate to remove the stripped paint from the treated surface, some paints may require multiple applications. In such cases, reapplication would continue until complete removal of the paint has been achieved. Preferably, one application of the liquid-to-solid matrix material would effect complete removal of the loosened paint on the surface.

The liquid-state composition used in the processes of this invention can be a polymer composition which may contain one or more optional additives. The polymers and additives are useful in such compositions as described below.

Polymeric Components. The polymeric component of the composition plays an important role in both the liquid and the solid states. In the liquid state, the polymeric component affects the rheological properties of the liquid-state composition, and its ability to penetrate inaccessible surface areas where residual paint may be hidden. This occurs by changing the internal surface area, interfacial free energy, interfacial friction and medium viscosity. In addition, the polymeric component's surface active properties, interaction abilities, associative forces and sorption propensities often overcome any residual attractive forces between the stripped paint and the base material thus lifting the paint from the surface of the base material and bonding it to the liquid-to-solid matrix material. Upon evaporation of the solvent, preferably water, the formation of a continuous solid-state matrix through physical and chemical interactions occurs which binds the paint to the solid-state matrix.

Removal of the paint bound to the solid-state matrix from the base material requires the proper balance of cohesive and adhesive energy densities so that the paint is not lost in the removal process. The preferred solid-state matrix should possess a favorable energetic relationship such that the ratio of cohesive force between the components of the solid state matrix to the adhesive force of the solid state matrix to the stripped paint equals or is greater than a value of 1.

Useful polymeric components for this invention, which can be in solution or dispersion form, include: acrylonitrile-containing copolymers, acrylonitrile/butadiene/styrene copolymers, butadiene copolymer rubbers, butadiene-styrene copolymers, chlorinated butadiene-styrene rubber; chlorinated butyl rubber; chlorinated isoprene rubber; chlorinated polyethylene, chlorosulfonated polyethylene, chlorinated rubber, chlorinated Neoprene rubbers, chloroprene rubber, chloroprene copolymers with methacrylic acid, chloroprene copolymers with 2,3-dichloro-1,3-butadiene, cellulosics, cellulose ethers, natural rubber, cis-1,4-polyisoprene, trans-1,4-polyisoprene, cyclized polyisoprene, Hevea rubber, Gutta Percha rubber, and epoxidized natural rubber; phosphazene rubber; polyacrylate homopolymers, copolymers and vehicles, polyacrylate copolymers containing acrylic or methacrylic acids, polydimethylsiloxane, polysulfide rubber, poly(vinyl acetate) homopolymer and copolymers, poly(vinyl alcohol), poly(vinyl butyral) or (vinyl formal), poly(vinyl chloride) homopolymer and copolymers; chlorinated poly(vinyl chlorides), and poly(vinyl chloride-vinyl acetate) copolymers, urethane rubbers, polyether urethanes, polyester urethanes, polyurethane dispersions, epichlorohydrin rubbers, ethylene oxide/propylene oxide rubbers; isobutylene rubbers; and poly(perchloroethylene). Although extensive, those skilled in the art will note that the components listed above are not meant to be all inclusive and that other polymeric components can be used.

Optional Additives. The addition of one or more agents, aids, modifiers, functional additives, dispersants, complexing molecules, antidotal compounds and macromolecules to the liquid-to-solid matrix material can contribute to the efficient accomplishment of the processes described herein. Examples of these optional additives include indicating enhancing compounds, pH control agents, dispersants, wetting agents, transition state agents, rheology control agents, as well as other additives and pigments.

1. pH Control Agents: As with the paint stripping formulations, the effectiveness of the liquid-to-solid matrix material can be dependent on controlling the pH of the liquid-state composition. While the preferred pH range is 7 to 12, certain situations may require pH values below 7. Agents that provide pH control between 7 and 12 include alkali metal bicarbonates, such as sodium bicarbonate; alkali metal hydroxides, such as potassium hydroxide, and sodium hydroxide; alkali metal phosphates, such as tetrapotassium pyrophosphate, and trisodium phosphate; alkali metal silicates, such as potassium metasilicate and sodium metasilicate; ammonium hydroxide; dialkyl substituted ammonia derivatives, such as dimethylamine, diethylamine, diisopropylamine, diethanolamine, morpholine, piperazine and piperidine; monoalkyl substituted ammonia derivatives, such as methylamine, ethylamine, and ethanolamine, and trialkyl substituted amines, such as trimethylamine, triethylamine and triethanolamine. Agents such as tetrapotassium pyrophosphate and trisodium phosphate can also serve as dispersants for the contaminant by providing suspending action.

2. Dispersants: Dispersants promote favorable interactions by lowering the internal energy and surface tension to provide better integration between the liquid-to-solid matrix material and the stripped paint. Dispersants can facilitate the binding of the liquid-to-solid matrix material to the stripped paint at their interface by means of molecular aggregation and micelle formation, thus improving the removal process of the paint from the surface of the base material.

Preferred amounts of dispersant range from about 0.01 to about 5%, based on the total weight of the liquid-state composition. Examples of dispersants include: anionic copolymer sodium salts, 2-amino-2-methyl-1-propanol, ammonium salts of acrylic acid copolymers, esterified disodium sulfosuccinate derived from an alkanolamides, 3,5-dimethyl-1-hexyn-3-ol, blends of nonionic surfactants, sodium 2-ethylhexyl sulfate, amine alkylaryl sulfonates, alkylaryl polyether alcohols, diglycol coconate.

3. Wetting Agents: Wetting agents perform several important functions, such as stabilizing the liquid-state of the liquid-to-solid matrix material from phase separations, lowering the internal energy of the liquid-to-solid matrix material so that the components with widely different energies are homogeneous, and lowering the surface tension so that spreading and penetration occurs on all types of paints and base materials. These agents assist in the binding to the stripped paint by emulsification, solubilization and wetting. The preferred level of use provides a liquid-to-solid matrix material whose surface tension is below about 40 dynes/cm². Preferred amounts of wetting agents generally range from about 0.05 to about 6%, based on the total weight of the liquid-state composition.

Examples of useful wetting agents include: cocamide DEA, sorbitan ester ethoxylates, alkylbenzene sulfonates of isopropylamine, alkyl ethoxylates, sodium diester sulfosuccinate, phosphate esters of alkylaryl ethoxylate, polyoxyethylated tridecyl alcohol, nonylphenol ethyleneoxide, block copolymers of ethylene oxide and propylene oxide, polyalkylene oxide-modified polymethylsiloxane, sodium lauryl ethoxysulfate, sodium lauryl sulfate, octylphenol polyether alcohol, sodium alkylaryl polyether sulfates, polyoxyethylene sorbitan monolaurates, sodium alkylarylsulfonates, alcohol ether sulfates, polyalkylene glycol ethers and fluorosurfactant.

4. Transition State Agents: The rate of transition from the liquid state to the solid state matrix can be enhanced by the use of agents that promote the transition to the solid state based in drying and/or hardening. Preferred amounts of such agents range from about 0.5 to about 10%, based upon the total weight of the liquid-state composition. Examples of transition state agents of the invention include: acetone, 1,4-butanediol, cellosolve acetate, cyclohexanol, cyclohexanone, diacetone alcohol, diethylene glycol, dimethylformamide, dimethylsulfoxide, dipropylene glycol, ethylene glycol monobutyl ether, ethyl acetate, ethyl alcohol, ethylene glycol, furfuryl alcohol, glycerine, isophorone, isopropyl alcohol, isobutyl carbinol, methyl ethyl ketone, methyl carbinol, n-propyl acetate, n-propyl alcohol, propylene glycol, n-methylpyrrolidone, tetrahydrofuran, Texanol-2,2,4-trimethyl-1,3-pentanediolmonoisobutyrate, tetrahydrofurfyl alcohol and triethylene glycol.

5. Rheology Control Agents: The rheological properties of the liquid-to-solid matrix material control the mass transport and thus, the spreading of the liquid-state to contact the stripped paint and also, penetration into crevices and other inaccessible surface regions. Rheology control agents also can be used to prevent the liquid-to-solid matrix material from running off the vertical surfaces of the base material. Rheology control agents should be used preferably, in amounts that yield a viscosity range of from about 50 to about 110 KU and a sag resistance range of from about 5 to about 45 wet mils (from about 0.5 to about 8% based on total weight of the liquid-to-solid matrix material).

Examples of these agents include some types of clays, hydroxyethyl celluloses, modified hydroxyethyl cellulosics, cellulosic polymers, poly (acrylic acid), polyether polyurethanes, and proteins such as casein, water soluble polysaccharides and xanthan gum and guar.

6. Other Additives and Pigments: The liquid-to-solid matrix material may contain other functional additives such as foam control agents, agents which lower the glass transition temperature, preservatives, microbicides, flow control agents, crosslinking agents, dyes and/or pigments, as needed and as readily recognized by those skilled in the art.

### EXAMPLES

TABLE 1
Percent of Total

| | Sample Number | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| Components | | | | | | | | | | | | | | | | |
| Benzyl Alcohol | 30 | 30 | 30 | 30 | 30 | 30 | 30 | 30 | 30 | 30 | 30 | 30 | 30 | 30 | 30 | 30 |
| Glycolic Acid | 7 | 7 | 7 | 7 | 7 | 7 | 7 | 7 | 7 | 7 | 7 | 7 | 7 | 7 | 7 | 7 |
| Hydrogen Peroxide | 4.5 | 4.5 | 4.5 | 4.5 | 4.5 | 4.5 | 4.5 | 4.5 | 4.5 | 4.5 | 4.5 | 4.5 | 4.5 | 4.5 | 4.5 | 4.5 |
| Propylene carbonate | 2 | 5 | 10 | — | — | — | — | — | — | — | — | — | — | — | — | — |
| Dipropylene glycerol | — | — | — | 2 | 5 | 10 | — | — | — | — | — | — | — | — | — | — |
| methyl ether | | | | | | | | | | | | | | | | |
| Ethylene carbonate | — | — | — | — | — | — | 2 | 5 | 10 | — | — | — | — | — | — | — |
| Oleocal 112 | — | — | — | — | — | — | — | — | — | 2 | 5 | 10 | — | — | — | — |
| Butylene carbonate | — | — | — | — | — | — | — | — | — | — | — | — | 2 | 5 | 10 | — |
| Water | 56.5 | 53.5 | 48.5 | 56.5 | 53.5 | 48.5 | 56.5 | 53.5 | 48.5 | 56.5 | 53.5 | 48.5 | 56.5 | 53.5 | 48.5 | 58.5 |
| Total | 100 | 100 | 100 | 100 | 100 | 100 | 100 | 100 | 100 | 100 | 100 | 100 | 100 | 100 | 100 | 100 |

Paint stripper formulations were prepared as illustrated in Table 1. The reagents were added to a tube in the order in which they are listed from top to bottom in Table 1. Each paint stripper sample from Table 1 was tested for paint stripping capabilities as follows. To a baked-enamel painted metal cabinet, 0.35 ml of the sample was applied in a thin film at room temperature (15-20 degree C.). All of the samples tested lifted the paint from the metal surface resulting in a blistered appearance within a 10 minute time period. Most favorably, sample numbers 3, 9, 13 and 15 completely lifted the paint with in a 6 minute period.

In a second study, formulations were prepared in an attempt to make paint stripper as a single phase solution. In Table 2, formulations were prepared with increasing levels of glycerine carbonate with varying amounts of benzyl alcohol. All formulations prepared were a single phase; however, only sample number 5 lifted the paint within a reasonable amount of time (15 minutes). The other four samples lifted the paint with in two hours.

TABLE 2
Percent of Total

| | Sample Number | | | | |
|---|---|---|---|---|---|
| | 1 | 2 | 3 | 4 | 5 |
| Components | | | | | |
| Benzyl Alcohol | 16 | 3 | 6 | 11 | 16 |
| Glycolic Acid | 4 | 1 | 1 | 3 | 4 |
| Hydrogen Peroxide | 3 | 0 | 1 | 2 | 3 |
| Glycerine carbonate | 30 | 10 | 20 | 25 | 20 |
| Water | 47 | 86 | 73 | 60 | 57 |
| Total | 100 | 100 | 100 | 100 | 100 |

In a third experiment, we tested different formulations of the single phase paint stripper. Here, we varied the benzyl alcohol and the peroxide. Table 3 illustrates the nine different formulations that were tested. Samples 1, 2 and 4 showed the best results in that these 10 formulations lifted the paint within eight minutes. Formulations 5, 7 and 8 lifted the paint with 10 minutes and were slower due to a higher concentration of peroxide. The remaining formulations in Table 3 lifted the paint within 15-20 minutes. These formulations were the slowest presumably due to the lower concentration of benzyl alcohol coupled by the higher concentration of peroxide.

TABLE 3

| | Sample Number | | | | | | | | |
|---|---|---|---|---|---|---|---|---|---|
| | 1 | 2 | 3 | 4 | 5 | 6 | 7 | 8 | 9 |
| Components | | | | | | | | | |
| Benzyl alcohol | 30 | 25 | 20 | 30 | 25 | 20 | 30 | 25 | 20 |
| Glycolic acid | 7 | 7 | 7 | 7 | 7 | 7 | 7 | 7 | 7 |
| H2O2 | 5 | 5 | 5 | 7.5 | 7.5 | 7.5 | 10 | 10 | 10 |
| Glycerol carbonate | 20 | 20 | 20 | 20 | 20 | 20 | 20 | 20 | 20 |
| Water | 37 | 43 | 48 | 34.5 | 39.5 | 44.5 | 37 | 42 | 42 |
| Total | 100 | 100 | 100 | 100 | 100 | 100 | 100 | 100 | 100 |

In a fourth study, we varied the concentration of glycolic acid while holding the concentration of the other components to their most optimal concentrations. We varied the concentration of glycolic acid from between 1.75% to 7.0%. We found that sample number 5 lifted the paint within five to six minutes. Sample number 4 lifted the paint within a 15 minute period while the remaining three samples required between 1-3 hours to lift the paint.

TABLE 4
Percent of Total

| | Sample Number | | | | |
|---|---|---|---|---|---|
| | 1 | 2 | 3 | 4 | 5 |
| Components | | | | | |
| % Benzyl alcohol | 30 | 30 | 30 | 30 | 30 |
| % Glycolic acid | 1.75 | 2.45 | 3.5 | 5.25 | 7 |
| % H2O2 | 5 | 5 | 5 | 5 | 5 |
| Glycerol carbonate | 23 | 23 | 23 | 23 | 23 |
| Water | 40.25 | 39.55 | 38.5 | 36.75 | 35 |
| Total | 100 | 100 | 100 | 100 | 100 |

In a fifth study, we varied the concentration of hydrogen peroxide from 2 to 5%. We held all other components to their most favorable concentrations. We found that all of the samples lifted the paint with in a reasonable period of time (5-7 minutes).

TABLE 5

Percent of Total
Sample Number

| Components | 1 | 2 | 3 | 4 |
|---|---|---|---|---|
| Benzyl alcohol | 30 | 30 | 30 | 30 |
| Glycolic acid | 7 | 7 | 7 | 7 |
| H2O2 | 5 | 4 | 3 | 2 |
| Glycerol carbonate | 20 | 20 | 20 | 20 |
| Water | 38 | 39 | 40 | 41 |
| Total | 100 | 100 | 100 | 100 |

Since some paint removal applications occur in a non-horizontal field, the most optimal formulation as determined by these studies outlined above were used and added to a thickening agent. The purpose of the thickening agent is to provide a paint stripper that could adhere to painted surfaces that were not horizontal or if horizontal were faced down as is a ceiling. If a thickening agent is not used then the liquid paint stripper would run off by gravitational forces. This formulation included 30% benzyl alcohol, 7% glycolic acid, 5% hydrogen peroxide, 10% glycerine carbomate, 10% Carbapol and 38% water. The first step in preparing this formulation was to dissolve the Carbapol in the glycerine carbomate, then the benzyl alcohol, glycolic acid, peroxide and water were added in that order. The mixture obtained was thick and transluscent. We found that the addition of this formulation caused a lifting of the paint within a 5 minute period.

Thus, specific embodiments and applications of two-step coating removal process therefore have been disclosed. It should be apparent, however, to those skilled in the art that many more modifications besides those already described are possible without departing from the inventive concepts herein. The inventive subject matter, therefore, is not to be restricted except in the spirit of the present disclosure. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed:

1. A paint stripping formulation comprising on a weight (volume) basis:
at least 15-50% of benzyl alcohol or an alkyl substituted benzyl alcohol;
1-15% hydrogen peroxide;
10-40% of a carbonate such as propylene, ethylene, butylene or glycerine carbonate; and
0-60% of water.

2. The formulation of claim 1 wherein the benzyl alcohol is present in an amount of 20-30% by weight (volume), the hydrogen peroxide is present in an amount of 5-10% by weight, the glycerine carbonate is present in an amount of 15-25% by weight, and the water is present in an amount of 35-55% by weight.

3. The formulation of claim 1 further comprising 25-30% benzyl alcohol, 2-5% hydrogen peroxide, 10-20% glycerine carbonate and 35-50% water.

4. The formulation of claim 1 further comprising hydrogen peroxide added to the paint stripping formulation as a 30-35% solution in water.

5. The formulation of claim 1 further comprising at least one additive agents selected from the group consisting of thickeners, evaporation retardants, surfactants, pH control agents, corrosion inhibitors, preservatives, coloring agents, and fragrances.

6. The formulation of claim 5 wherein the additive agents comprise up to 10% by weight of the composition.

7. The formulation of claim 1 further comprising acidic accelerators.

8. A paint-stripping matrix-to-solid material comprising a polymeric material having a favorable energetic relationship such that the ratio of cohesive force between the components of the solid state matrix to the adhesive force of the solid state matrix to the stripped paint equals or is greater than a value of 1.

9. The material of claim 8 further comprising at least one member selected from the group consisting of acrylonitrile-containing copolymers, acrylonitrile/butadiene/styrene copolymers, butadiene copolymer rubbers, butadiene-styrene copolymers, chlorinated butadiene-styrene rubber; chlorinated butyl rubber; chlorinated isoprene rubber; chlorinated polyethylene, chlorosulfonated polyethylene, chlorinated rubber, chlorinated Neoprene rubbers, chloroprene rubber, chloroprene copolymers with methacrylic acid, chloroprene copolymers with 2,3-dichloro-1,3-butadiene, cellulosics, cellulose ethers, natural rubber, cis-1,4-polyisoprene, trans-1,4-polyisoprene, cyclized polyisoprene, Hevea rubber, Gutta Percha rubber, and epoxidized natural rubber; phosphazene rubber; polyacrylate homopolymers, copolymers and vehicles, polyacrylate copolymers containing acrylic or methacrylic acids, polydimethylsiloxane, polysulfide rubber, poly(vinyl acetate) homopolymer and copolymers, poly(vinyl alcohol), poly(vinyl butyral) or (vinyl formal), poly(vinyl chloride) homopolymer and copolymers; chlorinated poly(vinyl chlorides), and poly(vinyl chloride-vinyl acetate) copolymers, urethane rubbers, polyether urethanes, polyester urethanes, polyurethane dispersions, epichlorohydrin rubbers, ethylene oxide/propylene oxide rubbers; isobutylene rubbers; and poly(perchloroethylene).

10. The material of claim 8 further comprising at least one member selected from the group consisting of pH control agents, dispersants, wetting agents, transition state agents, and rheology control agents.

11. The material of claim 8 further comprising at least one functional additive selected from the group consisting of foam control agents, agents which lower the glass transition temperature, preservatives, microbicides, flow control agents, crosslinking agents, dyes and/or pigments.

12. A method of removing paint comprising the steps of:
applying a paint stripper to the painted surface;
applying a liquid-to-solid matrix to the painted surface;
allow sufficient time for drying of the matrix on the surface;
remove dried matrix from the surface.

13. The method of claim 12 wherein the matrix is applied at between 10 to 60 mil wet film thickness.

14. The method of claim 12 wherein the matrix includes the matrix of claim 8 and the stripper included the stripper of claim 1.
